(19) United States
(12) Patent Application Publication
(10) Pub. No.: US 2002/0080686 A1
(43) Pub. Date: Jun. 27, 2002

(54) Instantaneous drive mechanism for a date indicator

(75) Inventors: Jean-Philippe Rochat, Bienne (CH); Lucienne Serex, Preles (CH)

Correspondence Address: GRIFFIN & SZIPL, PC, SUITE PH-1, 2300 NINTH STREET, SOUTH, ARLINGTON, VA, 22204, US

(73) Assignee: Eta SA Fabriques d'Ebauches, Grenchen (CH)

(21) Appl. No.: 10/006,678

(22) Filed: Dec. 10, 2001

(30) Foreign Application Priority Data
Dec. 22, 2000 (CH) 2523/00

(51) Int. Cl. G04B 19/20; G04B 19/24

(52) U.S. Cl. 368/37

(57) ABSTRACT

The instantaneous date change mechanism includes driving means (3) and positioning means (7) for an indicator (1). The driving means (3) include a spring (6) which ends in a finger (4) acting on a tooth (5) of the indicator. The positioning means are formed in particular of a heel (8) inserted between two teeth (9, 10) of the indicator (1). The driving means (3) are arranged so that the heel (8) can be at least partially released from the indicator teeth when the indicator has to be driven.

The present invention relates to a mechanism for displaying the date on a timepiece, this mechanism including a toothed date indicator provided with figures appearing through an aperture, means for driving and positioning said indicator, the drive means being arranged to assure that the date is changed instantaneously at a determined time as a result of the action of a first finger resting on a tooth of the indicator while exerting a force on it resulting from the winding of a spring, and the positioning means being formed in particular by a member inserted between two teeth of said indicator when the latter is not being driven.

Numerous embodiments are known in which the date changes instantaneously at midnight unlike other proposed embodiments where this change last several hours, for example over one to two hours. Here the instantaneous change is abrupt, its duration being of the order of a second, or less.

A calendar-watch with instantaneous date change answering the definition of the first paragraph hereinbefore is disclosed for example in the document CH 446198 (U.S. Pat. No. 3,352,103). The date change device of this watch includes a wheel completing one revolution in 24 hours and which carries a spiral shaped spring one end of which is provided with a finger which acts on a tooth of the date indicator to make it move forward by one step per day. This device is fitted with a conventional jumper spring engaged in a gap formed by two teeth of the indicator under the return force of a spring. No connection exists between the jumper spring and the return spring which are the means for positioning the indicator and the spiral shaped spring which acts as drive means for said indicator.

A few hours before the date change moment, the finger comes to rest on a tooth of the indicator. Since the 24 hour wheel is turning, the spiral shaped spring is wound, accumulating energy, the indicator being held stationary by the jumper spring. At the date change moment, a rigid member fixed to the 24 hour wheel, in this case the other end of the spiral shaped spring, comes to rest on the back of the finger, which makes the indicator move forward, while forcing the jumper spring to leave its gap against the return force of the spring acting on said jumper spring. Thus the indicator can move forward by one step instantaneously until the jumper spring, still pressed by the return spring, falls into the next gap.

The mechanism which has just been described suffers from one major drawback, that of requiring considerable torque from the motor member of the timepiece in order to extract the jumper spring from its gap, which is contrary to the proper working of the watch. The accuracy and working duration are thus affected.

In order to avoid these drawbacks, the mechanism according to the present invention, made in accordance with the description of the first paragraph hereinbefore, is characterised in that the drive means are arranged to co-operate with the positioning means so that said member can be at least partially released from the teeth of the indicator when the latter has to be driven.

Made in this manner, it will be seen that the mechanism of the invention requires less torque to work and that there is less friction between the parts present than that found in conventional systems, while proper positioning of the indicator is assured even in the event that the timepiece undergoes shocks. It will be added that the proposed mechanism is simple and compact which naturally makes it cheaper.

The invention will now be described in detail relying on the following description of an embodiment, such description being illustrated by the annexed drawings, in which:

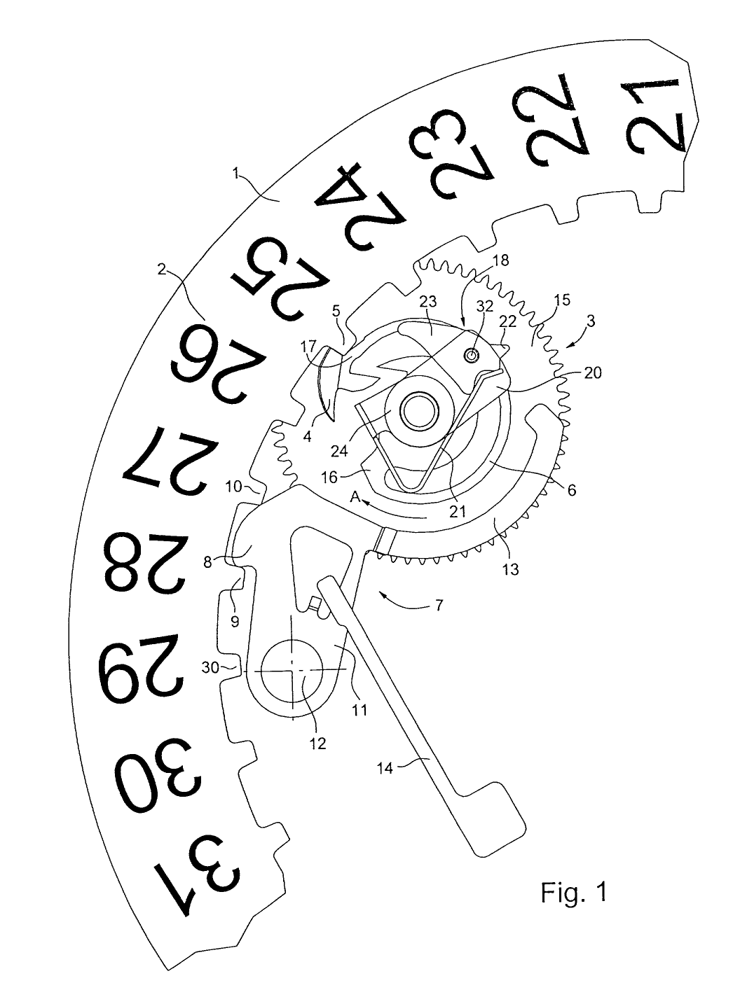

FIGS. 1 to 5 are plan views of the mechanism according to the invention illustrated in five different stages from the rest position to the completion of the function;

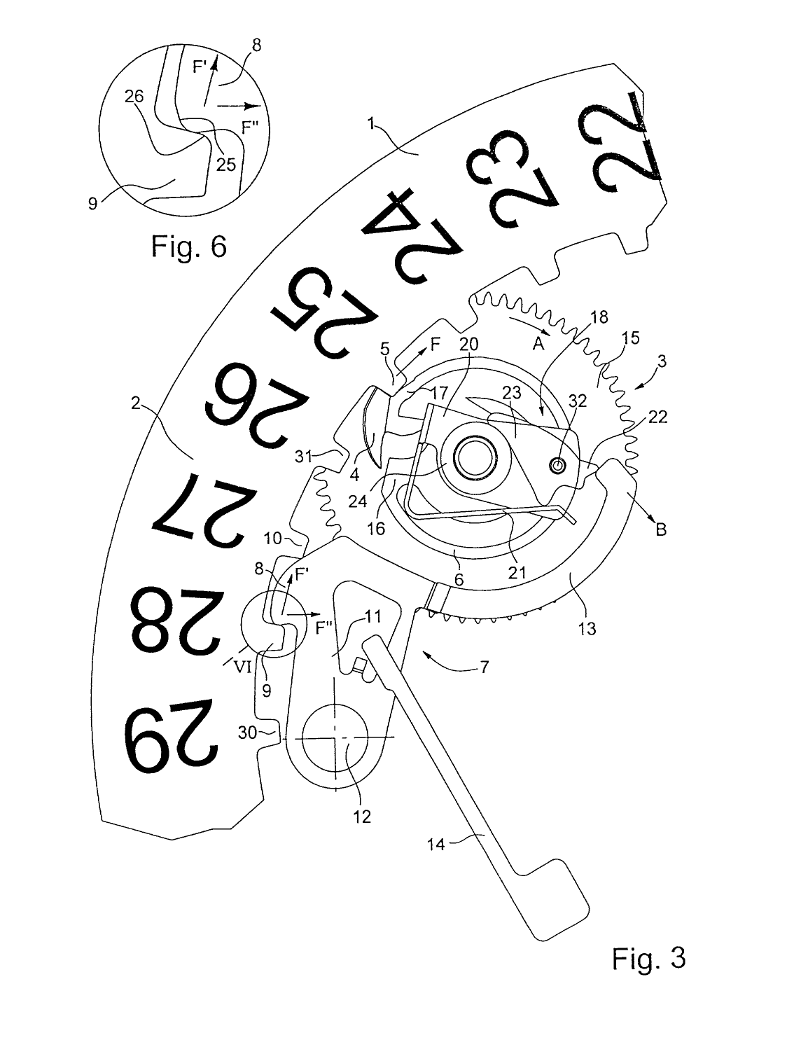

FIG. 6 is an enlargement of the zone VI indicated in FIG. 3; and

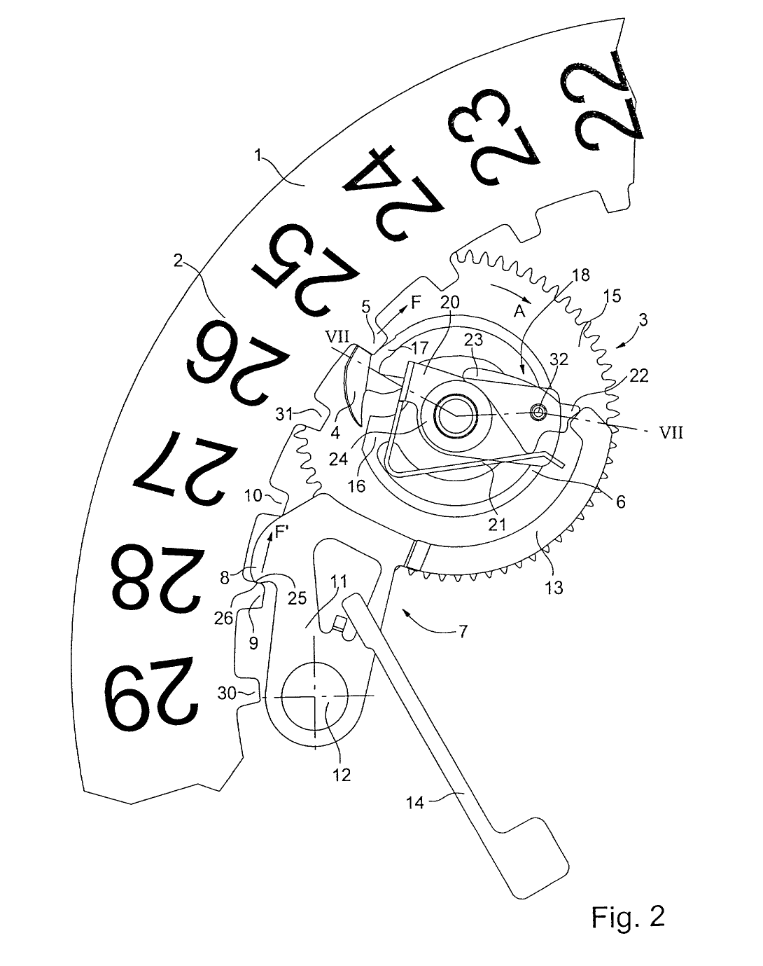

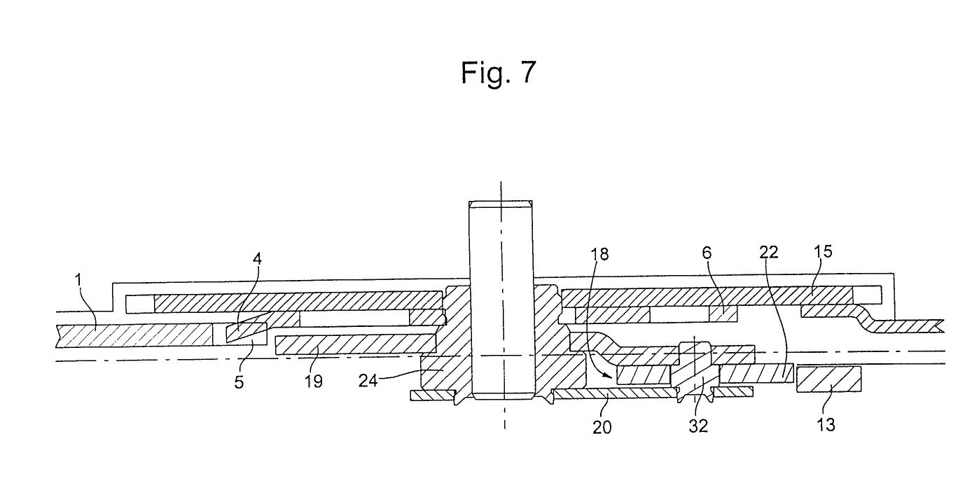

FIG. 7 is a cross-section along the line VII-VII shown in FIG. 2.

As can be seen in FIGS. 1 to 5, the mechanism for displaying the date on a timepiece includes a date indicator 1. In the construction shown, this indicator 1 is a ring provided with thirty one teeth, five of these having been referenced 5, 9, 10, 30 and 31. Indicator 1 is provided with FIGS. 2 which appear through an aperture located at 3 o'clock and not shown here. Driving means 3 are arranged to assure an instantaneous date change at a determined time, generally at midnight. This instantaneous change is achieved as a result of the action of a first finger 4 which rests on a tooth 5 of the indicator (situation in FIGS. 1 to 4) while exerting a force F on this tooth resulting from the winding of a spring 6. Indicator 1 is indexed by positioning means 7 which give the indicator a well defined angular position when it is not being driven so that the date figure is well centred in the aperture through which it appears. These positioning means are formed in particular by a member 8 which is inserted between two teeth 9 and 10 (situation in FIGS. 1 to 3) of the indicator when the latter is not being driven.

As appears in FIGS. 1 to 5 and as will be explained in more detail hereinafter, driving means 3 are arranged to co-operate with positioning means 7 so that member 8 can be released at least partially from the teeth of indicator 1 when said indicator has to be driven. This constitutes the essential character of the present invention which will now be explained in detail.

The Figures show that positioning means 8 include a lever 11 pivoting around an arbour 12. This lever is provided with a heel 8 which forms the aforecited member 8 and which is inserted between the two teeth 9 and 10 of indicator 1 to position the latter when it is not being driven. Lever 11 also includes an arm 13 arranged to be activated by driving means 3 so as to extract, at least partially, heel 8 from teeth 9 and 10 and thus to allow indicator 1 to be released when it has to be driven. These positioning means 7 are completed by a return spring 14 which acts on lever 11 to hold heel 8 between two teeth 9 and 10 of the indicator.

The same FIGS. 1 to 5 also show that the driving means include a 24 hour wheel 15 driven by the movement which is included in the timepiece but which is not shown in the Figures. At the centre of the 24 wheels is fixed an end 16 of a spring having a resilient arm 6 shaped in the arc of a circle, the other end 17 of the spring being provided with the aforecited first finger 4, this finger coming to rest a certain time, for example 3 hours, before the change time on a tooth 5 of indicator 1. 24 hour wheel 15 also carries a second finger 18 arranged to come into contact with arm 13 of lever 11 and to make this lever pivot until its heel 8 is at least partially extracted from teeth 9 and 10 of indicator 1.

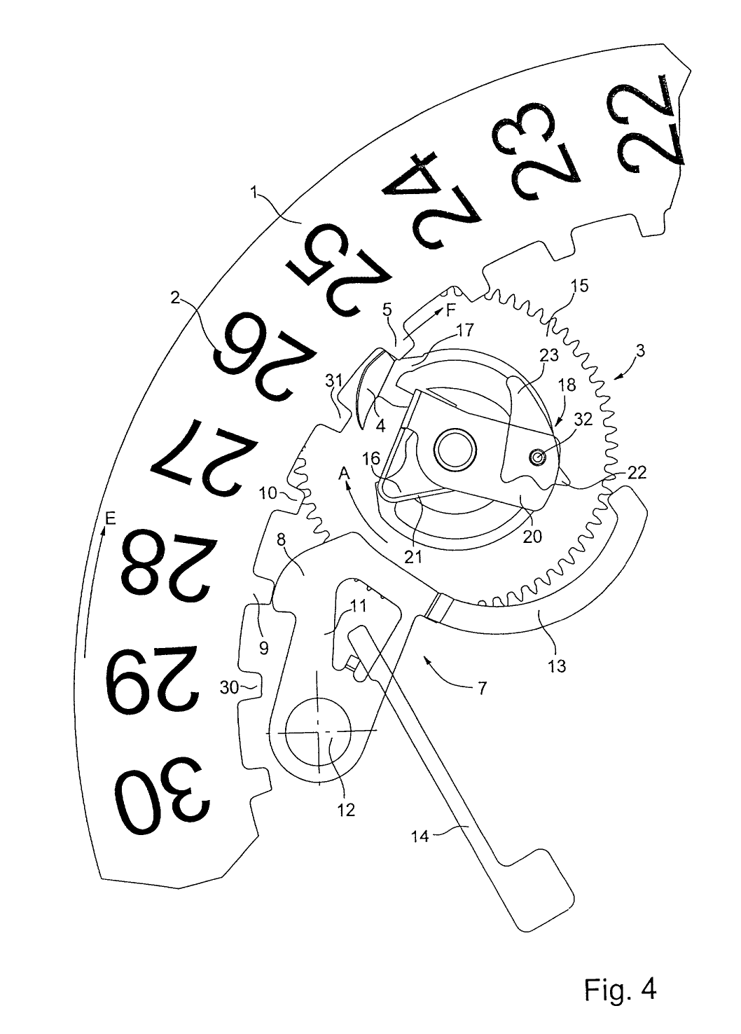

Second finger 18 which has just been mentioned, is mounted so as to pivot between two plates 19 and 20 (see also FIG. 7) secured to 24 hour wheel 15 while being held in a determined position by a return spring 21, this determined position being shown in FIGS. 1, 4 and 5. Second finger 18 which pivots around an arbour 32, has a front portion 22 capable of coming into contact with arm 13 of lever 11 and a back portion 23 capable of abutting against an arbour 24 carrying 24 hour wheel 15. This second finger 18 starts to pivot on itself as soon as its front portion 22 comes into contact with arm 13 of lever 11, this pivoting continuing until back portion 23 of finger 18 abuts against arbour 24 of wheel 15 (FIG. 2). During such pivoting, return spring 21 becomes taut. Then, lever 11 can pivot in turn partially extracting heel 8 from teeth 9 and 10 of indicator 1 (FIG. 3). Finally, second finger 18 returns to its determined position as soon as its front portion 22 leaves arm 13 of lever 11, this determined position being re-established by return spring 21 relaxing (FIG. 4).

If FIG. 2 is examined more particularly now, it will be understood that force F exerted by first finger 4 on tooth 5 of indicator 1 induces an equivalent force F′ on one flank 25 of heel 8 of lever 11, this force F′ being exerted by a flank 26 of one 9 of indicator teeth 9 and 10 between which heel 8 is inserted. Referring now to FIG. 3 and to the enlargement of zone VI of this Figure shown in FIG. 6, it can be seen that flank 25 of heel 8 and flank 26 of tooth 9 which are in contact with each other are bent such that when heel 8 is partially extracted from the indicator toothing by driving means 3, as is apparent in FIGS. 3 and 6, force F′ exerted by tooth 9 finishes pushing heel 8, in the direction of arrow F″, out of the toothing to start the instantaneous move forward by one step of indicator 1.

FIGS. 1 to 5 will now be examined in turn to explain how the mechanism according to the invention works.

FIG. 1 shows the mechanism in a rest position. The 24 hour wheel is turning in the direction of arrow A and drives with it finger 4 located at end 17 of spring 6 in the shape of an arc of a circle. Finger 4 enters into contact with tooth 5 of indicator 9. Heel 8 of lever 11 is well inserted between two indicator teeth 9 and 10 so that the latter is locked and well positioned. Heel 8 is held in place by return spring 14. Second finger 18 is in a normal determined position by return spring 21.

By continuing to rotate in the direction of arrow A, the 24 hour wheel applies finger 4 onto tooth 5 with a force F as is shown in FIG. 2. Arc of a circle spring 6 becomes taut. Second finger 18 has pivoted on itself around arbour 32 and is in a position in which its front portion is in contact with arm 13 of lever 11 and its back portion abuts against arbour 24 of 24 hour wheel 15. Return spring 21 is taut. Heel 8 of lever 11 is still inserted between indicator teeth 9 and 10 and a force F′ similar to force F, begins to be exerted on flank 25 of heel 8.

FIG. 3 shows a following operating step. 24 hour wheel 15 continues to turn in the direction of arrow A, and arm 13 of lever 11 moves in the direction of arrow B pushed by front portion 22 of second finger 18. This movement causes lever 11 to rotate, tension in return spring 14, and heel 8 to move, which partially leaves the space comprised between indicator teeth 9 and 10. At this moment, as already mentioned hereinbefore, force F′ exerted by tooth 9 has the effect of pushing heel 8 out with a force materialised by arrow F″.

Once heel 8 has come out of the space between teeth 9 and 10, the situation is as shown in FIG. 4. As soon as the heel has come out of said space, driven by the energy accumulated in the spring, the indicator can move rapidly in the direction of arrow E. FIG. 4 shows heel 8 resting on the top of tooth 9 and in transition between the space located between teeth 9 and 10 where it was previously and the space located between teeth 9 and 30 where it will soon be positioned. FIG. 4 also shows that when lever 11 is extracted from the space located between the teeth, arm 13 moves significantly away from the position which it occupied in FIG. 3 thus releasing second finger 18 which returns to its determined position via the action of return spring 21.

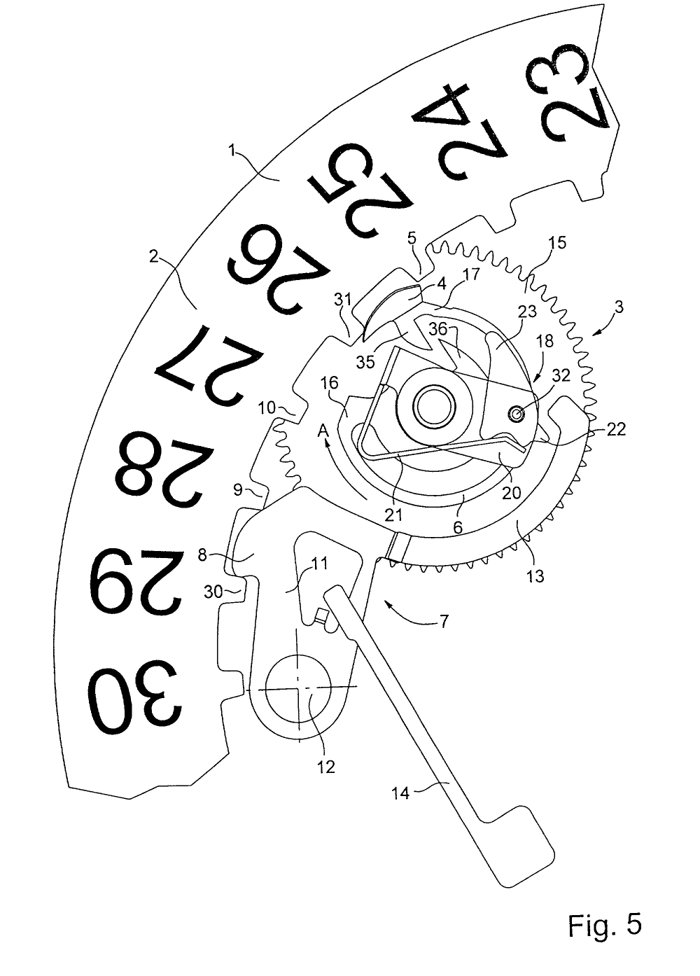

FIG. 5 shows the mechanism when the function has ended, i.e. when the indicator has moved forward by one step. Heel 8 is now between teeth 9 and 30 and return spring 14 acting on lever 11 is relaxed. In this situation, first finger 4 is released from tooth 5 which it was driving and can thus begin another cycle by coming to rest on the next tooth 31. The importance in proposing a second finger 18 which can pivot as indicated hereinbefore will be stressed here. Indeed, without this, arm 13, or more exactly the end of this arm, would abut against front portion 22 of finger 18 returning to the place which it occupies in the final phase (FIG. 5).

The foregoing concerned a heel 8 which is at least partially extracted from the indicator teeth, the final removal being achieved by the force exerted by the flank of a specially bent tooth on a flank of the heel which is also specially bent. One may however imagine a construction in which second finger 18 is sufficiently long to totally extract the heel in one go from the teeth between which it rests. Such an embodiment has however not been retained because of the problems it poses as regards the kinematics of the assembly.

As the working of the system has been explained hereinbefore, it will be understood that the instantaneous change mechanism of the invention is advantageous because of the energy saving it offers in comparison to the embodiment cited as the prior art (CH 446198). Indeed, in the mechanism of the invention, the path travelled by return spring 14 of lever 11 is much shorter than the path travelled by the return spring of the jumper spring used in the aforecited document since half of this path has already been travelled as a result of the mechanical connection existing between the driving and locking means. This results in a decrease of the torque to be provided by the motor member of the timepiece, and thus improved accuracy of the latter as well as improved operating autonomy. It will also be repeated that the mechanism of the invention is simple to implement and it is compact, hence reduced manufacturing and assembly costs.

This description will finish with a few words on the problems which usually arise concerning setting the time and date of the timepiece.

The date of indicator 1 is set via the stem of the timepiece and via a mechanism which is not shown, different from that described and acting directly on the indicator teeth. The date is set in the clockwise direction of the indicator. The manual force applied to the stem is then sufficient to remove lever 11 from its gap between two teeth.

The same is not true, however for the time which can be set in both directions. By rotating the stem one acts on the hands of the timepiece and indirectly on the 24 hour wheel. If this wheel rotates in the clockwise direction, setting the time poses no problem and the date change mechanism works as described hereinbefore. However, if 24 hour wheel 15 rotates in the anti-clockwise direction i.e. an opposite direction to arrow A (see FIG. 5), butting may occur by first finger 4 against tooth 31 if the finger is in the position shown in FIG. 5, then damage to the mechanism may occur. In order to avoid this phenomenon, end 17 of spring 6 is fitted with a beak 35 able to cooperate with another beak 36 made at fixed end 16 of spring 6. When 24 hour wheel 15 rotates in the anti-clockwise direction, butting first occurs by finger 4 on tooth 31, which causes beak 35 to abut against beak 36. If the 24 hour wheel continues to rotate, beak 35 slides against beak 36, such sliding allowing finger 4 to retract in front of tooth 31 and finally the finger to pass without obstruction over tooth 31. It is to be noted that such a device is already suggested in the aforecited document CH 446198.

What is claimed is

1. A Mechanism for displaying the date on a timepiece, including a toothed date indicator provided with figures appearing through an aperture, means for driving and positioning said indicator, the driving means being arranged to assure that the date is changed instantaneously at a determined time as a result of the action of a first finger resting on a tooth of the indicator while exerting a force on it resulting from the winding of a spring, the positioning means being formed in particular by a member inserted between two teeth of said indicator when the latter is not being driven, and the driving means being arranged to co-operate with the positioning means so that said member can be at least partially released from the teeth of the indicator when the latter has to be driven.

2. The mechanism according to claim 1, wherein said positioning means include a lever pivoting around an arbour and provided with a heel and an arm, the heel forming said member inserted between two teeth of the indicator to position the latter when it is not being driven, and the arm being arranged so as to be activated by the driving means so as to extract, at least partially, the heel from said teeth and thus to allow the indicator to be released when the latter has to be driven, a return spring acting on the lever to keep the heel between two teeth of the indicator.

3. The mechanism according to claim 2, wherein the driving means include a 24 hour wheel driven by the movement of the timepiece, a spring having a resilient arm in the shape of an arc of a circle one end of which is fixed to the centre of the 24 hour wheel and the other end of which is provided with said first finger coming to rest a certain time before said determined time on a tooth of the indicator, the 24 hour wheel also carrying a second finger arranged to come into contact with the arm of the lever and to cause the latter to pivot until its heel is extracted at least partially from said teeth of the date indicator.

4. The mechanism according to claim 3, wherein the second finger is mounted so as to pivot between two plates secured to the 24 hour wheel while being held in a determined position by a return spring, this second finger having a front portion capable of coming into contact with the arm of the lever and a back portion capable of abutting against an arbour carrying the 24 hour wheel, in that this second finger pivots on itself from the moment that its front portion comes into contact with the arm of the lever and until the moment that its back portion abuts against the arbour of the wheel, the return spring becoming taut during this time, from which the lever can pivot, and in that said second finger returns to its determined position as soon as its front portion (22) leaves the lever arm as a result of the return spring (21) relaxing.

5. The mechanism according to claim 3, wherein the force exerted by the first finger on the date indicator induces an equivalent force on a flank of the heel of the lever, said force being exerted by a flank of one of the indicator teeth between which the heel is inserted and in that the heel flank and the tooth flank which are in contact with each other are bent so that when said heel is partially extracted from the indicator toothing by the drive means, the force exerted by the tooth finishes pushing the heel out of the toothing, which allows the indicator to move forward instantaneously by one step.
